(19) United States
(12) Patent Application Publication
(10) Pub. No.: US 2006/0117966 A1
(43) Pub. Date: Jun. 8, 2006

(54) Fruit slicing and core removing device

(76) Inventor: Ming-Shih Chang, Taipei (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 11/248,699

(22) Filed: Oct. 13, 2005

Related U.S. Application Data
(63) Continuation-in-part of application No. 11/004,923, filed on Dec. 7, 2004, now abandoned.

(51) Int. Cl. A47J 25/00

(52) U.S. Cl. 99/545

(57) ABSTRACT

The device includes a base having an upper cutter tube with a receiving opening on its top end, a lower seat; a gouge, formed concentrically inside the cutter tube, flares downward throughout the tube to the seat and then inclined downward to a wall to form a discharge opening; a set of blades disposed inside the receiving opening has a cylindrical blade at its center, a number of straight blades radially surround the cylindrical blade anchor their proximal ends at slots on the inner wall of the cutter tube; a sliding bracket has a central bore for pivotally receiving the gouge, a number of grooves radially formed on the top surface of the sliding bracket for embedding the straight blades respectively; a spiral spring fits over the gouge and withstands the sliding bracket, a collar screwed inside the receiving opening to interlock the radial straight blades.

### PARENT APPLICATION ABOUT THE PRESENT INVENTION

The present invention is a C-I-P application of Ser. No. 11/004,923 filed on 7 Dec. 2004, now is abandoned.

### FIELD OF THE INVENTION

The present invention is to provide a household coring and slicing device, which is used for slicing and coring the fruits and then automatically to show the sliced meat of fruits on spiral spring supported sliding bracket within a transparent mask.

### BACKGROUND OF THE INVENTION

Core portions of the fruits such as apple, pear and avocado are not totally edible, the users frequently washes them through clean water and then cutting them into pieces. The core portion sometimes has bitter taste, when extracting juice from the fruits, a few may have spoiled core portion to tarnish the produce invisibly.

On the market, coring instruments have straight or annular blades for coring and slicing the fruits are manufactured for sale, or food items are to cut and core by manual operated or automatic machine, such as pineapple,peeling and coring machines.

Due to the instruments and machines for cutting fruits may have the protruded edges exposed out to be a dangerous factor for users, a spiral spring supported sliding bracket is provided in the present invention for safely slicing and coring the fruits, only one step to impel the plunger (which is a transparent frame) downward to slice, core and show the fruits aftermath.

The present invention is similar to the prior arts and compares with them hereinafter, such as U.S. Pat. No. 419,722 entitled “apple corer and slicer” assigned to Michael Siersdorfer on 21 Jan. 1890. In that, a slicing plate (12), a gouge (6), and a spiral spring (19) are combined to core and slice fruit meat. A lever arm (22) is used to achieve the mechanical advantage (MA). The fruit is sliced on the floor.

U.S. Pat. No. 1,146,085 entitled “apple coring and slicing machine” assigned to Samuel J. McVey on 13 Jul. 1915. In which, grooves (29) are formed to receive the cutting edges of the knives (16), a lengthened tube (30) can dispose of the cut out cores of the apple. Even the cutting knives (16) can be adjusted and adapted to the slots (17) so as to form a bigger or smaller coring central orifice. Flanges (21) can prevent the knives (16) from pivotal movement about bolts. A tapered finger fits into the flared sleeve to expel the cores.

U.S. Pat. No. 4,441,413 entitled “pineapple cutter” assigned to Mori, et al on 10 Apr. 1984, in which a slant groove is provided for the rod to operate the tubular cutter to remove the peel and core. But the machine is designed for peeling a cylindrical pineapple.

U.S. Pat. No. 4,546,545 entitled “pineapple cutter” assigned to Hirano, et al on 15 Oct. 1985. The operator cuts the crown and butt from the pineapple and then the peel divided into four pieces by a U-type pushing member. Both hands and thumbs exert pressure on the pushing member to press down and cut off the peel.

U.S. Pat. No. 4,606,263 entitled “apparatus for peeling pineapples” assigned to Ross, et al on 19 Aug. 1986. Spring (48) length and tension are selected and adjusted to provide the elasticity necessary to return cutter (20) and core tube (42) to their rest position, while locked in the raised position by locking collars (50).

U.S. Pat. No. 4,718,333 entitled “peeling system” assigned to Piere, et al on 12 Jan. 1988. The apparatus has a housing enclosing the knife means—the cylindrical and straight knives for peeling hard external surface of the objects into four pieces, in addition, two openings shielded by sliding doors must in close position to operate. Further, the jaws (34) grapple and rotate the object for peeling, in that, piston rod retracted into the piston cylinder of the jaws to rotate.

U.S. Pat. No. 5,067,397 entitled “pineapple cutting and coring device” assigned to Daniel P. Healy on 26 Nov. 1991. The device includes a blade moving means (30) for moving the cutting blades up and down toward and away from the cutting board base plate (12) due to two interconnecting bars (44) (50) spaced apart and parallel to each other, and upon two fulcrum ends two lever arms (36) (38) connected to the cutting board base plate 12, further guide means (56) includes guide plate with retaining disk to receive the edible portion of pineapple. Even the inside/outside circular grooves formed in the top surface of the cutting board for receiving the cylindrical cutting edge of inside/outside cylindrical cutting blades.

U.S. Pat. No. 5,101,718 entitled “cutting device” assigned to Thomas Lin on 7 Apr. 1992. Downward movement of the orange (50) over the slicing blades (20a) (20b) to be divided into halves, further subjected to lower and shorter scoring blades (22a) (22b) (24a) (24b) and coring blade to cut each orange half into partially three segments with boundaries intact and remove the core. Until the orange half put in a hemispherical cradle (102) with a scoop (112) rotated through 180° to peel and separate them into three pieces.

U.S. Pat. No. 5,337,480 “subdividing device” assigned to Ralph Codikow on 16 Aug. 1994. Preferrably the blades (30) cantilevered upwardly from the circumferential surface (16) to form the attacking point (39) typically about three degrees, further juxtaposed the attacking points (39) to form an opening (40) to an expanding channel (41), the work piece (18) forced into contact with the attacking points (39) by urging means (43) thereby subdividing the work piece (18) into segments and allows for reciprocating movement of the plunger (45) relative to the blades (30). Urging means (43) comprises plunger (45), guide sleeves (51) engaged to a taller post (47) by a broach or a shorter guide post (47) by a half-moon relief, the plunger (45) is axially rotated. The lower surface of the plunger (45) can be formed as a column (55) has a chamfer (57) for engaging and centering the work piece (18), the slots (59) in the column (55) for interdigitating with the blades. Further the protective wall (61) prevents the operator's hands or fingers from damage caused by contact with the leading edge (36) or attacking points (39) of the blades.

U.S. Pat. No. 6,148,719 entitled “mechanical coring device” assigned to Neris Poltielov on 21 Nov. 2000. A coring blade housing (30) for containing the coring blade (46) or teeth within the lower collar (36) having the adjustment screw (38) tightly securing thereto, the coring blade (46) circularly cuts around the core of the food item. Thereafter, the pressure on the hand press is reversed, and the coring blade is withdrawn from the food item (28) with the core captured inside the coring blade (46). An internal cross member (54) located in bore (52) removes the core of the food item with a shearing force by rotation.

U.S. Pat. No. 6,748,854 entitled “melon cutter” assigned to James E. Barnard on 15 Jun. 2004. The ring (24) rests on the base (52) in an annular groove (98) opening. The cutting basket (12) includes arched cutting elements at least 8˜12, a central support member (92), the handle (26) of the cutting basket is rotated 30˜45°, the rotating cutting elements separate the melon meat from the rind, the melon cut in halves, the seeds and pulp removed before cut into pieces.

### SUMMARY OF THE INVENTION

Since in the cited prior arts, there has neither transparent mask for covering a sliced fruit, nor a bracket supported by spring showing the pieces after coring and slicing. Accordingly, the present invention is aimed to provide a coring and cutting device neither power supply circuitry nor electricity-consuming consideration. Rather, after use, the device of the present invention is easy to clean.

The present invention provides a fruit slicing and core removing device comprising: a base (1) having a cutter tube (11) at its upper end portion, a seat (12) at its lower end portion, a hollowed core removing gouge (13) is formed concentrically in the cutter tube (11) throughout to the seat (12) and then inclined downward through a wall of the seat (12); a set of blades (2) having a cylindrical blade (21) at its center diametrically opposed to a central orifice of the gouge (13), a number of straight blades (22) surround the cylindrical blade; a sliding bracket (3) mounted inside the cutter tube (11) with a central bore for pivotally receiving the gouge (13), a number of grooves formed radially around the bore for embedding the straight blades (22); a spiral spring (4) fits over the gouge (13) and resists against the sliding bracket (3); an annular collar (5) secured to the receiving opening of the cutter tube (11) interlocks the straight blades (22).

### BRIEF DESCRIPTION OF THE DRAWINGS

FIG. 1: an exploded view of the fruit slicing and core removing device in the first embodiment of the present invention;

FIG. 2: an assembled view of FIG. 1;

FIG. 3: a cross section view of FIG. 1;

FIGS. 4˜6: schematic views of FIG. 1;

FIG. 7: an exploded view of the fruit slicing and core removing device in the second embodiment of the present invention; and

FIG. 8: a cross section view of FIG. 7.

### GLOSSARY

Base (1)

A set of blades (2)

Sliding bracket (3)

Spiral spring (4)

Collar (5)

Plunger (6)

Fruit (7)

Core removing device (10)

Cutter tube (11)

Seat (12)

Gouge (13)

Cylindrical blade (21)

Straight blades (22)

Annular knife frame (23)

Grooves (31)

Guided bolts (32)

Flange (33)

Sleeve (34)

Push block (61)

Core (71)

Fruit meat (72)

Slots (111)

Guided channels (112)

### DETAILED DESCRIPTION OF THE PREFERRED EMBODIMENTS

The description is described according to the appended drawings hereinafter, in the accompany drawings like reference characters designate the same or similar parts throughout the several views.

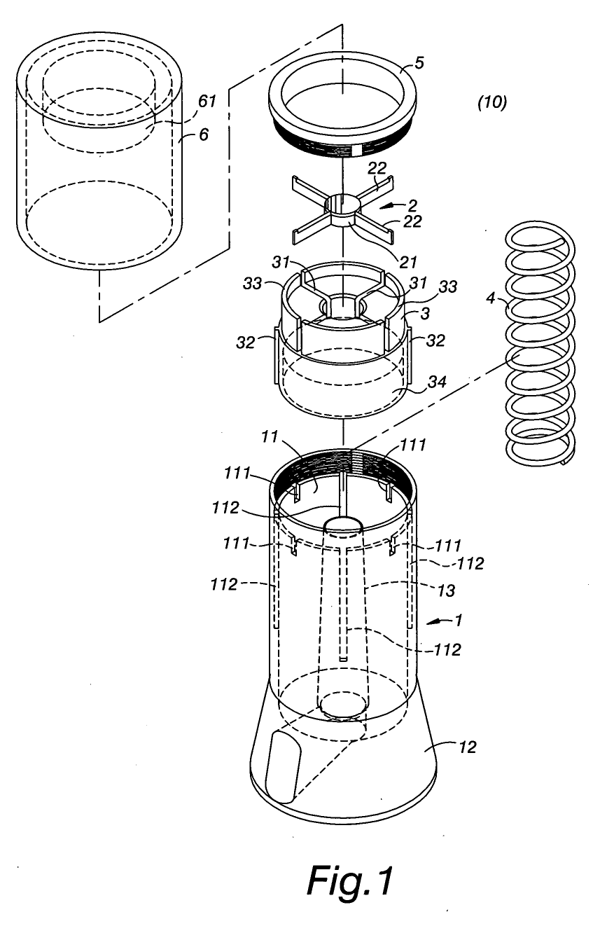

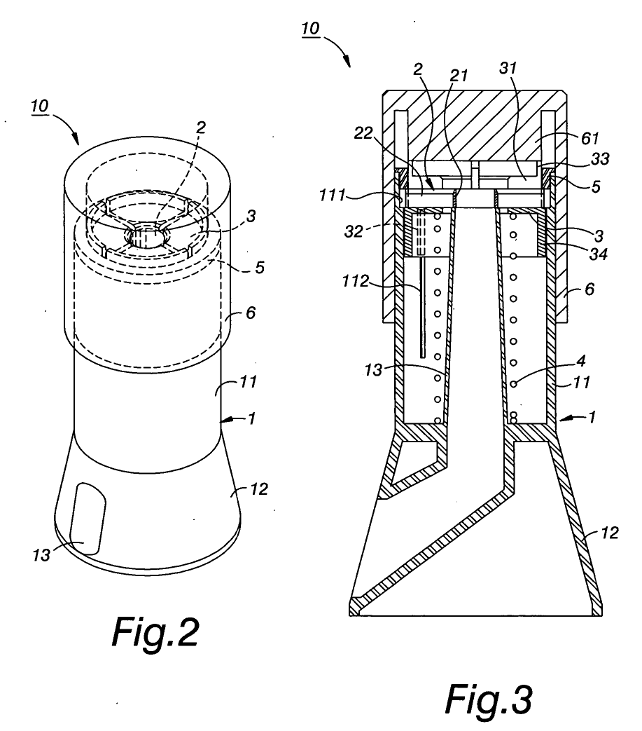

As shown in FIG. 1, the fruit slicing and core removing device (10) includes a base (1), a set of blades (2), a sliding bracket (3), a spiral spring (4), a collar (5) and a plunger (6); after combination, an assembled view is illustrated as shown in FIG. 2.

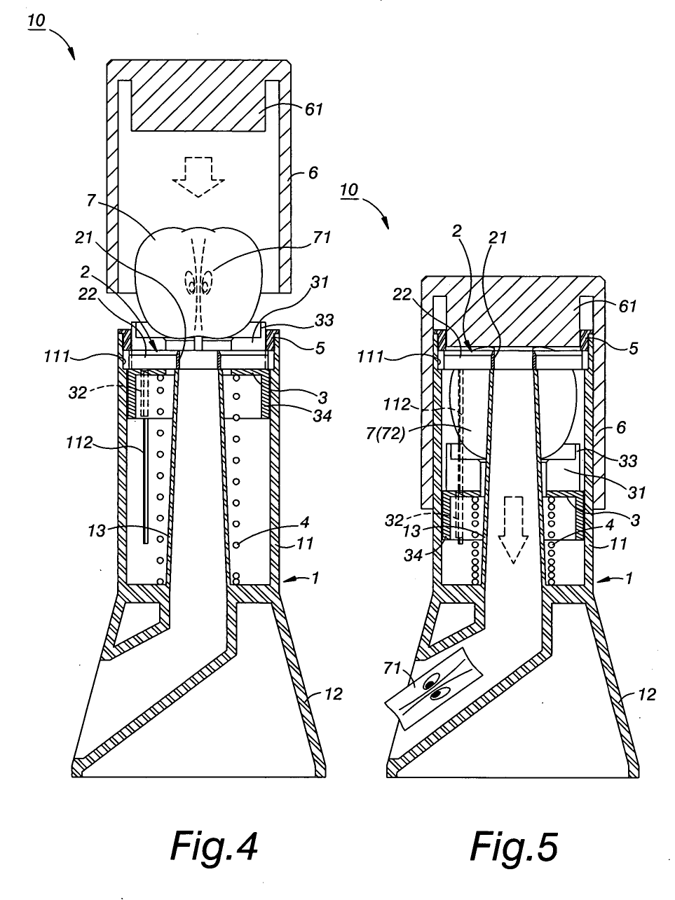

As shown in FIG. 3, which is a cross section view of FIG. 1, the base (1) has a cutter tube (11) at its upper end portion. The cutter tube (11) has a “concentric” gouge (13) at its center, the top end of the cutter tube is formed as a receiving opening, the top end of the gouge is formed as a central orifice. The base (1) also has a seat (12) at its lower end portion. The gouge (13) flares slightly downward to the seat (12), and then inclined downward through a lower wall of the seat (12) to form a discharge opening.

The set of blades (2) is disposed above the gouge (13). A cylindrical blade (21) is disposed at its center which is diametrically opposed to the central orifice of the sleeve (13), the cylindrical blade (21) is vertically aligned and corresponding to the substantially same diameter central orifice of the sleeve (13). Straight blades (22) are disposed around the outer circle of the cylindrical (21) equidistantly. A proximal end of a straight blade is anchored at a slot (111) on the inner wall of the cutter tube (11) respectively.

The sliding bracket (3) has a central bore for pivotally receiving the core removing gouge (13) vertically fit in, on the top surface of the sliding bracket (3), a number of grooves (31) formed around the central bore radially and equidistantly. When the sliding bracket (3) is urged to ascend to the upper end portion of the gouge (13), a straight blade (22) is embedded in a groove (31) respectively. Top rim of the sliding bracket (3) is projected up to form a circular sectioned flange (33); the bottom rim of the sliding bracket (3) is enclosed by a sleeve (34), in other words, the sleeve (34) fits over the bottom rim of the sliding bracket (3). A number of guided bolts (32) are disposed to the outer wall of the sleeve (34) equidistantly, which can be adapted and corresponding to a number of guided channels (112) formed on the inner wall of the cutter tube (11) respectively. The bolts (32) of the sleeve can be led into the channels (112) of the cutter tube so that the sliding bracket (3) can be moved up and down in the cutter tube (11) stably without deflection.

The spiral spring (4) fits over the gouge (13), a distal end of the spring resists against the sliding bracket (3). Constantly, the spiral spring is extended to support the sliding bracket (3) flush with the receiving opening of the cutter tube (11), and the straight blades (22) of the set of blades (2) are embedded into the grooves (31) on the surface of the sliding bracket until an outer force exerts pressure to the plunger (6).

An annular collar (5) is secured to the receiving opening of the cutter tube (11) by screwing. The annular collar (5) encloses the circular sectioned flange (33), but the proximal ends of the straight blades (22) anchored at the slots (111) on the inner wall of the cutter tube (11) in position respectively. The positioned straight blades (22) thus interlocked by the collar (5), further the sliding bracket (3) and the set of blades (2) can be prevented from breaking away the cutter tube (11).

Plunger (6) fits over the top end portion of the cutter tube (11), the inner diameter of the plunger (6) is larger than the outer diameter of the cutter tube (11). A push block (61) is projected downward from inside the top end portion of the cutter tube (11), the outer diameter of the push block (61) is smaller than the inner diameter of the cutter tube (11) and the collar (5).

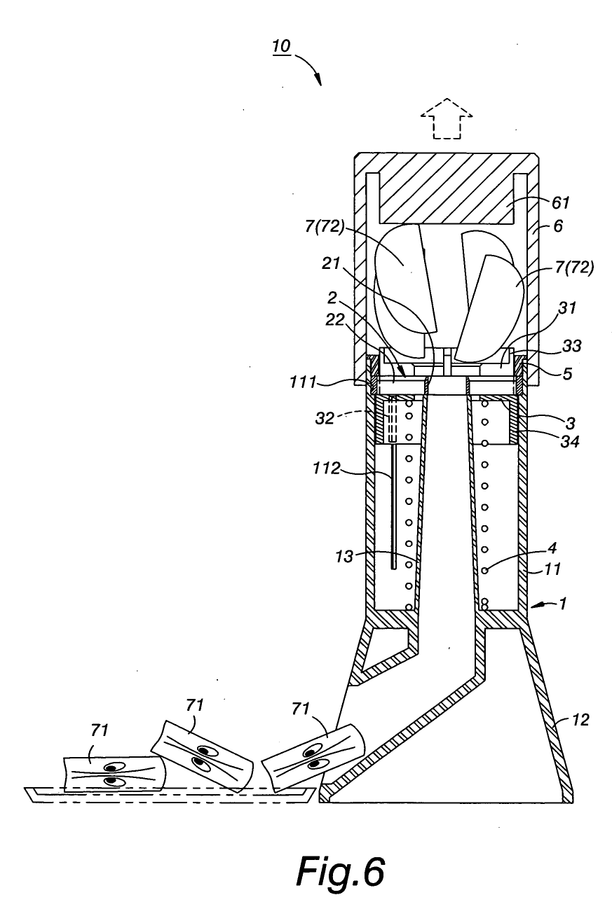

As shown in FIGS. 4˜6, schematic views of the present invention are illustrated. In FIG. 4, a fruit (7) placed on top of the sliding bracket (3), the outer diameter of the fruit (7) can be approximately equal to the outer diameter of the flange (33) of the sliding bracket (3) but less than the inner diameter of the collar (5). When the plunger (6) pressing downward, the push block (61) is exerted pressure to the fruit (7). The fruit (7) endured the pressure can urge the sliding bracket (3) to descend together in contact with the set of blades (2). In FIG. 5, when the fruit (7) passing through the set of blades (2), the core (71) is cut out by the cylindrical blade (21), and then dropped into the central orifice of the gouge (13); finally, the core (71) is expelled out from the discharge opening of the seat (12). Meanwhile, the fruit meat (72) is also divided into pieces by straight blades (22). In FIG. 6, after releasing the pressure exerted to the fruit 7, the sliding bracket (3) is lifted by an extension of the spiral spring (4) with pieces of fruit meat (72) and the plunger (6) back to the original position flush with the receiving opening of the cutter tube (11). The pieces of fruit meat (72) are pushed out on the cutter tube (11). After removing the plunger (6), the pieces of fruit meat (72) can be obtained from the cutter tube (11) and the sliding bracket (3). Thus, the fruits can be coring and slicing by one step, the cores (71) can be collected further disposed of or processed to transfer into the fertilizer.

### Second Embodiment

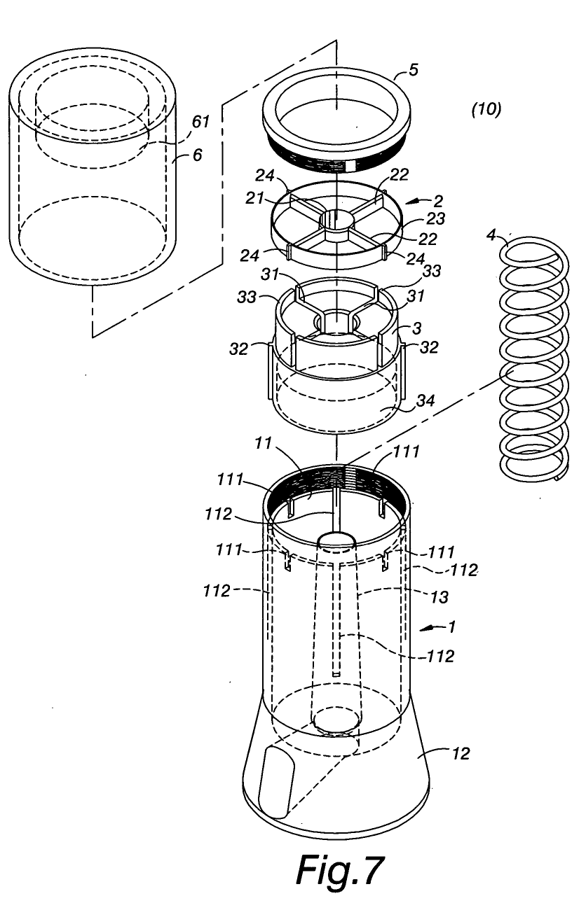

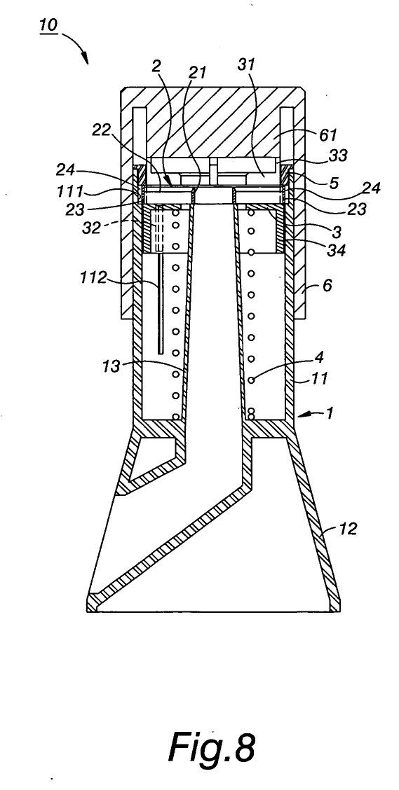

As shown in FIGS. 7 and 8, the fruit slicing and core removing device (10) has an annular knife frame (23) on the outer circle of the set of blades (2). In practice, the outer wall of the knife frame has positioning bolts (24) can be embedded into and secured to the slots (111) on the inner wall of the cutter tube (11) instead of the proximal ends of the straight blades.

The annular knife frame (23) is designed for the straight blades easy to assemble in position, further to endure the pressure equally. The whole strength of the knives structure can be improved. The set of blades are not easy to deform, or twist; the risk for damaging the set of blades in the process of production, assembly, and stack are eliminated.

What is claim is claimed:

1. A fruit slicing and core removing device comprising:
a base (1) having a cutter tube (11) at its upper end portion, a seat (12) at its lower end portion, a gouge (13) is formed concentrically in the cutter tube (11) throughout to the seat (12) and then inclined downward through a lower wall of the seat (12);
a set of blades (2) having a cylindrical blade (21) at its center diametrically opposed to a central orifice of the gouge (13), a number of straight blades (22) surround the cylindrical blade are anchored at the slots (111) on the inner wall of the cutter tube (11) with their proximal ends respectively;
a sliding bracket (3) mounted inside the cutter tube (11) with a central bore for pivotally receiving the gouge (13), a number of grooves formed radially around the bore for receiving the straight blades (22) respectively;
a spiral spring (4) fits over the gouge (13) and resists against the sliding bracket (3); an annular collar (5) secured to the receiving opening of the cutter tube (11) interlocks the straight blades (22).

2. A fruit slicing and core removing device according to claim 1, wherein a plunger (6) fits over the base (1), the inner diameter of the plunger (6) is larger than the outer diameter of the cutter tube (11).

3. A fruit slicing and core removing device according to claim 1, wherein a sleeve (34) encloses bottom rim of the sliding bracket (3) with a number of guided bolts disposed to the outer surface of the sleeve (34), which are led in the corresponding channels formed on the inner wall of the cutter tube (11).

4. A fruit slicing and core removing device according to claim 1, wherein an annular knife frame disposed around the outer circle of the straight edges, a number of positioning bolts formed on the outer wall of the knife frame embedded in the slots (111) on the upper end portion of the inner wall of the cutter tube (11).

5. A fruit slicing and core removing device according to claim 1, wherein the top rim of the sliding bracket (3) projected up to form a circular sectioned flange (33).

6. A fruit slicing and core removing device according to claim 1, wherein the gouge (13) flares slightly downward.
